(19) United States
(12) Patent Application Publication
(10) Pub. No.: US 2017/0072980 A1
(43) Pub. Date: Mar. 16, 2017

(54) FOLDABLE INFANT WALKER

(71) Applicant: Kingstar Business Group Corporation, Road Town (VG)

(72) Inventor: Gengyin Wang, Road Town (VG)

(21) Appl. No.: 14/856,510

(22) Filed: Sep. 16, 2015

(51) Int. Cl. B62B 7/06; B62B 7/00

(52) U.S. Cl. CPC B62B 7/06; B62B 7/004; B62B 7/006; B62B 7/064

(57) ABSTRACT

A foldable infant walker includes a base, a front support, a rear support and a walker chair. Respective bottom ends of the front support and the rear support are disposed relative to the base and rotatably connected to the base. A front end of the walker chair is detachably connected to an upper end of the front support. Because the front support and the rear support can be turned relative to the base and then folded, the folded infant walker whose whole volume is largely reduced can be easy to carry, store and manage. The folding operation is also simple and convenient.

### BACKGROUND OF THE INVENTION

1. Field of the Invention

This invention relates to an infant walker and relates particularly to a foldable infant walker.

2. Description of the Related Art

During the physical development of infants or toddlers, they may need different vehicles, such as infant or toddler walkers, learning walkers and scooters. These vehicles usually have a single function and can only be adapted to some particular growing stage of the infants. For example, when infants grow into children and become skilled in walking, the infant walker is useless. This situation causes the waste.

Some people have modified the infant walker by providing the infant walker with other functions whereby a significant improvement is brought about. Accordingly, one infant walker can be applied to a longer period of development of children and can also be adapted to children of different ages. However, such infant walker may have many components, and these components may occupy a larger space. Although the user tries to reduce the volume of the infant walker by detaching and folding the components, the operation is still complicated and the folded volume is still large. Thus, the infant walker is not easy to carry, store and manage, and this problem needs to be improved.

### SUMMARY OF THE INVENTION

It is an object of this invention to provide a foldable infant walker, the front support and the rear support of which perform a folding operation by turning relative to the base to largely reduce the whole volume of the infant walker. Thus, this invention is easy to cany, store and manage and is also provided with a simple and convenient folding operation.

To obtain the aforementioned object, the foldable infant walker of this invention includes a base, a front support, a rear support and a walker chair. Respective bottom ends of the front support and the rear support is disposed relative to the base and rotatably connected to the base. A front end of the walker chair is detachably connected to an upper end of the front support, and a rear end of the walker chair is detachably connected to an upper end of the rear support.

By comparison with the conventional infant walker, this invention takes advantage of the front support and the rear support which turn relative to the base and become folded to largely reduce the whole volume of the infant walker. Thus, this invention is easy to cany, store and manage and is also provided with a simple and convenient folding operation. Further, with the aid of a special connection between a walker chair, a scooter chair assembly and a rear support stem, a connecting support stem can be folded by turning and moved to a chamber, a rear end of a scooter chair can be adapted to a front end of the connecting support stem and positioned within the chamber, and the walker chair can be turned and then folded to abut against the scooter chair. Thus, the walker chair and the scooter chair assembly are concurrently turned rearward along with the front support and then folded to enter the base. This discloses a complete folded structure with detailed components held in position. Therefore, there are no separate accessories, and the occurrence of losing the accessories is prevented.

The structure and advantages of this invention are more apparent upon reading following descriptions of the preferred embodiments in conjunction with accompanying drawings.

### BRIEF DESCRIPTION OF THE DRAWINGS

FIG. 1 is a perspective view showing a foldable infant walker of a preferred embodiment of this invention which is used as an infant walker;

FIG. 2 is a perspective view showing a foldable infant walker of a preferred embodiment of this invention which is used as a learning walker;

FIG. 3 is a perspective view showing a foldable infant walker of a preferred embodiment of this invention which is used as a scooter;

FIG. 4 is a partial perspective view showing a rotating locking assembly of the preferred embodiment of this invention;

FIG. 5 is an exploded view of FIG. 4;

FIG. 6 is a schematic view showing that the front support turns to move toward the base of this invention;

FIG. 7 is a schematic view showing a first folding motion of the preferred embodiment of this invention;

FIG. 8 is a schematic view showing a second folding motion of the preferred embodiment of this invention;

FIG. 9 is a schematic view showing a third folding motion of the preferred embodiment of this invention, namely a complete folding state of this invention;

FIG. 10 is a partial perspective view showing a height adjustment structure at a rear end of the walker chair of the preferred embodiment of this invention; and

FIG. 11 is another partial perspective view showing a height adjustment structure at a front end of the walker chair of the preferred embodiment of this invention.

### DETAILED DESCRIPTION OF THE PREFERRED EMBODIMENTS

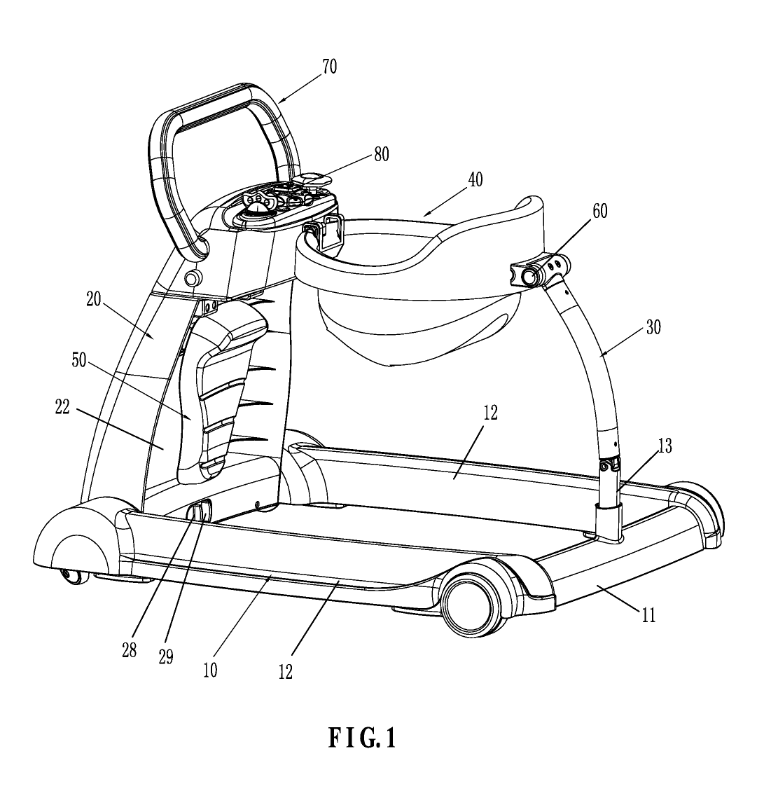

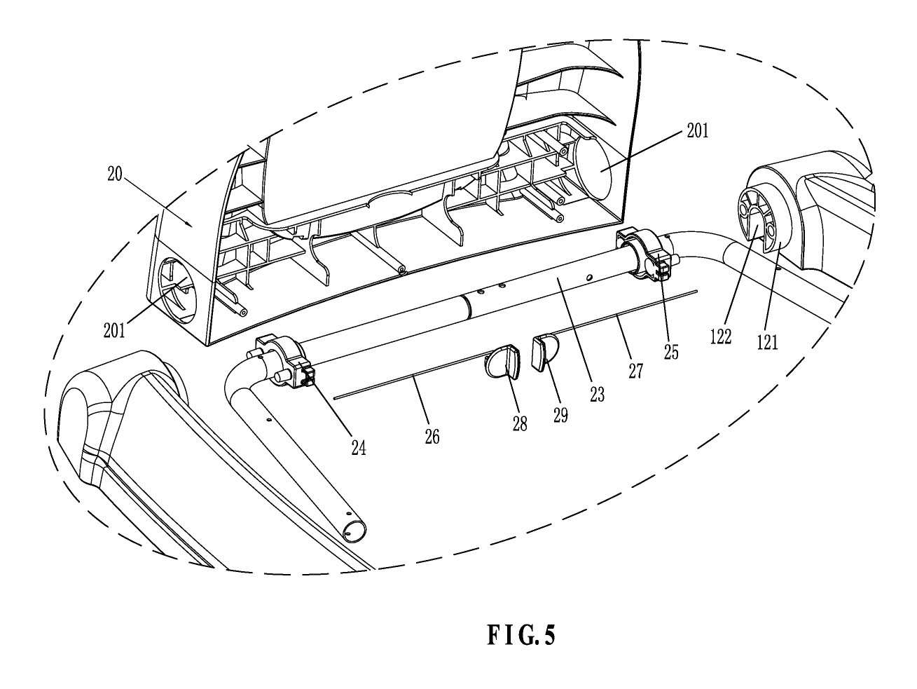

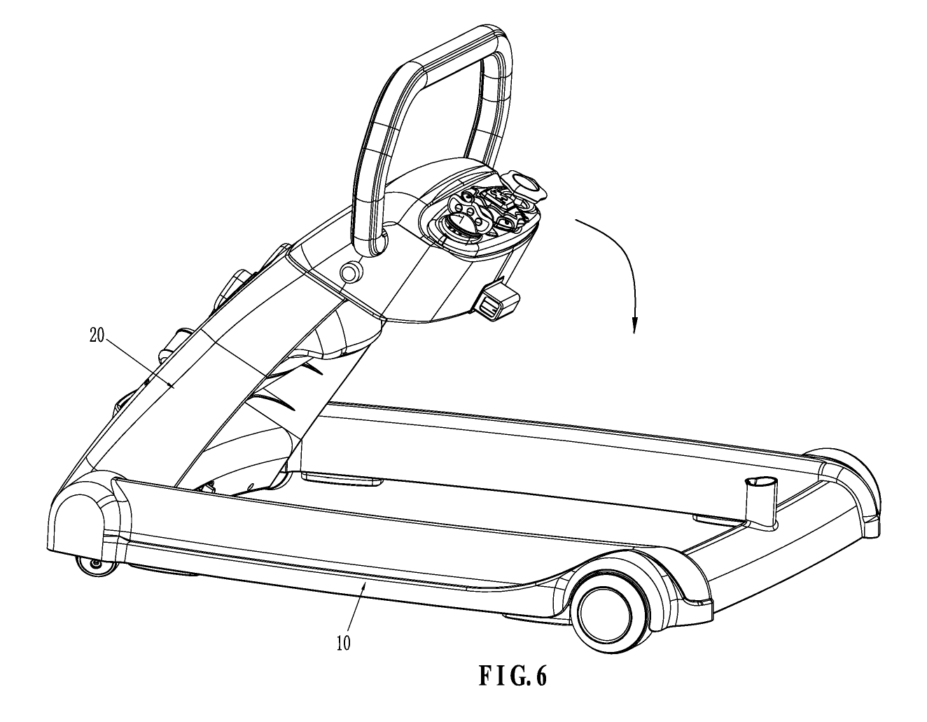

Referring to FIG. 1 through FIG. 11, a structure of this invention includes a base 10, a front support 20, a rear support, a walker chair 40 and a scooter chair assembly 50. Wherein, respective bottom ends of the front support 20 and the rear support are disposed relative to the base 10 and rotatably connected to the base 10. A front end of the walker chair 40 is detachably connected to an upper end of the front support 20. A rear end of the walker chair 40 is detachably connected to an upper end of the rear support. In this preferred embodiment, the rear support includes a rear support stem. The rear end of the walker chair is detachably connected to an upper end of the rear support stem. A lower end of the rear support stem is disposed relative to a rear frame and rotatably connected to the rear frame.

The base 10 includes a rear frame 11, a left and a right side frame 12 respectively connected to a left end and a right end of the rear frame 11. The two ends of the rear frame 11 are detachably connected to respective rear ends of the left and the right side frame 12. A lower end of the front support 20 can be connected to respective front ends of the left and the right side frame 12 directly or indirectly. The lower end of the rear support stem 30 is connected to a middle portion of the rear frame 11. The front end of the walker chair 40 is detachably connected to the upper end of the front support 20. The rear end of the walker chair 40 is detachably connected to the upper end of the rear support stem 30. The scooter chair assembly 50 includes a scooter chair 51 and a connecting support stem 52 connected to a front end of the scooter chair 51. A front end of the connecting support stem 52 is detachably connected to the front support 20 or relatively rotatably connected to the front support 20 by turning around the front support 20. A rear end of the scooter chair 51 is detachably connected to the upper end of the rear support stem 30.

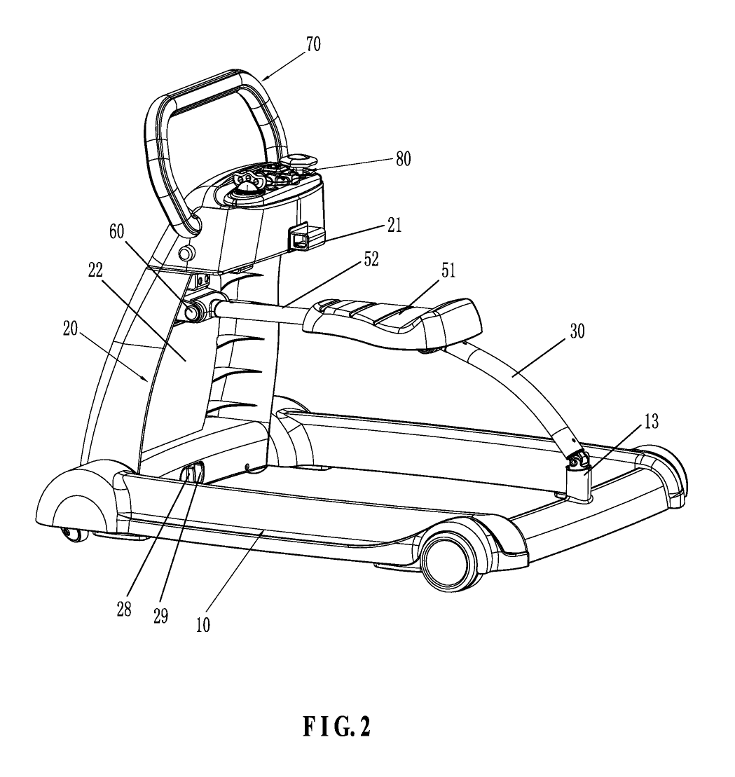

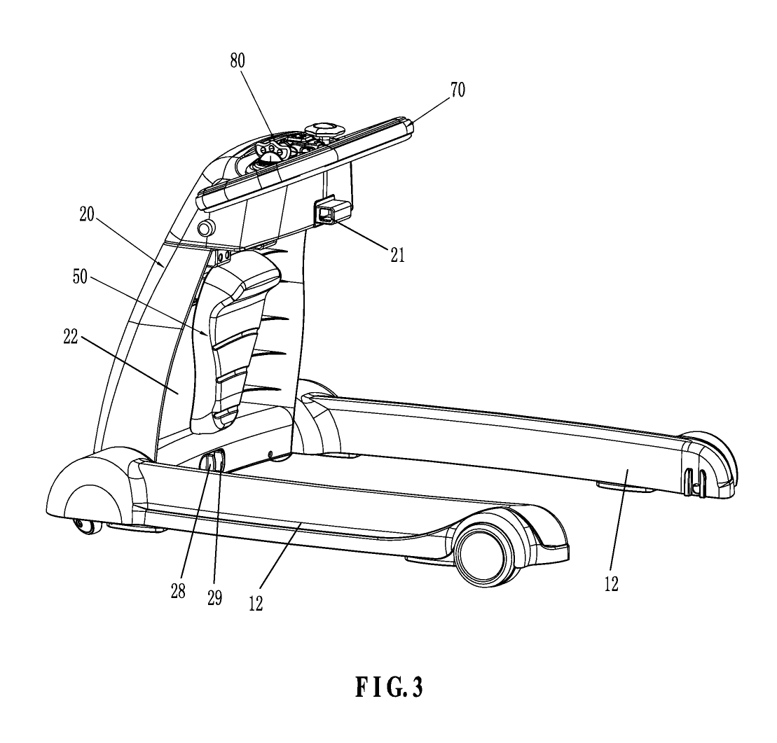

To install the walker chair 40, the front end of the walker chair is connected to the upper end of the front support 20, and the rear end thereof is connected to the upper end of the rear support stem 30. Thus, an infant walker is provided, as shown in FIG. 1. To install the scooter chair assembly 50, the rear end of the scooter chair 51 is connected to the upper end of the rear support stem 30. Thus, a learning walker is provided, as shown in FIG. 2. Further, FIG. 3 shows a scooter structure which removes the rear support stem 30 and the rear frame 11.

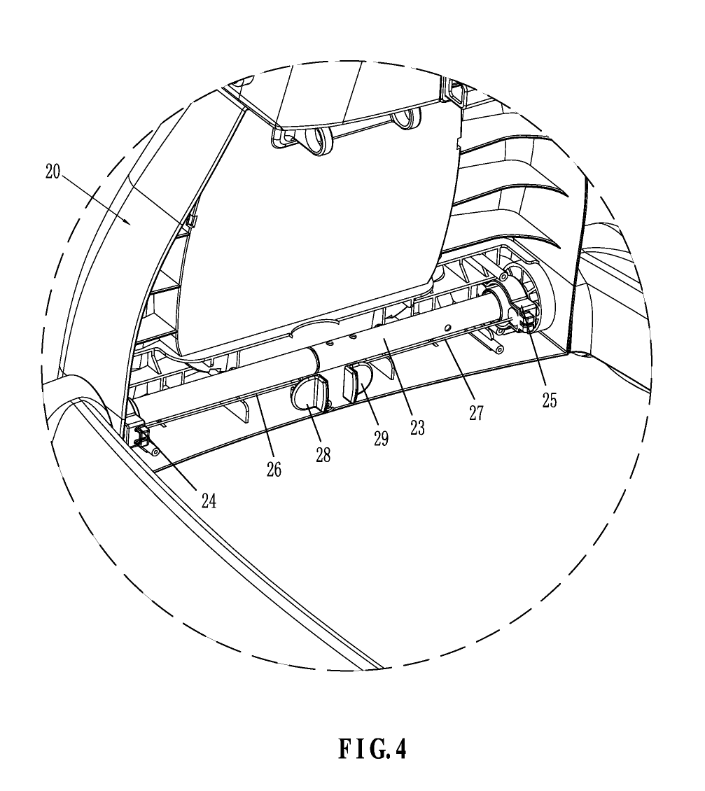

Referring to FIG. 4 through FIG. 6, a rotating locking assembly is disposed between the front support 20 and the base 10. The rotating locking assembly includes a connecting axle 23, a left locking part 24, a right locking part 25, a left cable 26, a right cable 27, a left pull button 28 and a right pull button 29. The connecting axle 23 is connected between respective front ends of the left and the right side frame 12. The left locking part 24 and the right locking part 25 are wound round the connecting axle 23. The left cable 26 is connected between the left pull button 28 and the left locking part 24. The right cable 27 is connected between the right pull button 29 and the right locking part 25. A bottom portion of the front support 20 is rotatably wound round the connecting axle 23. A left and a right of the bottom portion of the front support 20 form respective adapter openings 201. Respective adapter posts 121 project from the left and the right side frame 12. Respective locking bores 122 are formed on the corresponding adapter posts 121. The adapter posts 121 pass the corresponding adapter openings 201. The left locking part 24 and the right locking 25 can be lodged in or withdrawn from the corresponding locking bores 122 under the operation of the left pull button 28 and the right pull button 29.

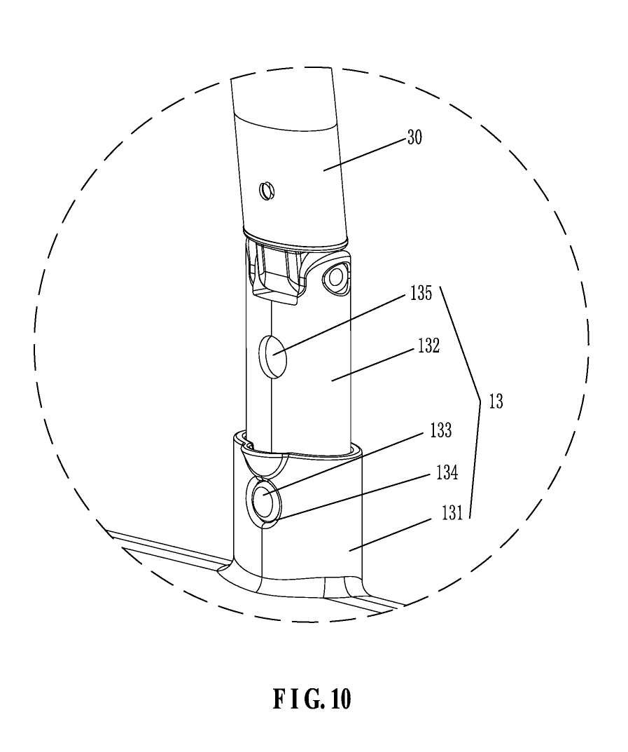

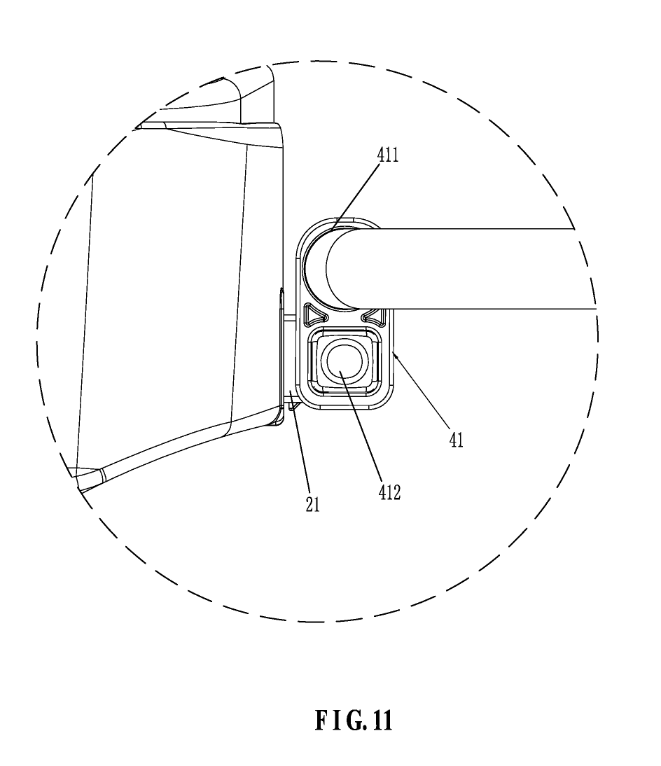

FIG. 10 and FIG. 11 show a height adjustment structure of the infant walker.

Referring to FIG. 10, a height adjustment structure at the rear end of the walker chair is disclosed. A connecting part 13 extends upward from a middle portion of the rear frame 11. The connecting part 13 includes a tube seat 131, an adjusting tube 132 and a locking button 133. The lower end of the rear support stem 30 is relatively rotatably connected to an upper end of the adjusting tube 132, thereby allowing the rear support stem 30 to turn relative to the rear frame 11. In other words, the rear support stem can have a rotation relative to the base 10. A lower end of the tube seat 131 is connected to the middle portion of the rear frame 11. An adaptive slot is longitudinally extended in the tube seat 131. A positioning hole 134 exposed to an outside is formed on a slot wall of the adaptive slot. The adjusting tube 132 has a hollow inside. The adjusting tube 132 is capable of sliding into the adaptive slot of the tube seat 131. At least two spaced-apart matching holes 135 are formed on a tube wall of the adjusting tube 132. An up-down sliding motion of the adjusting tube 132 allows the locking button 133 to pass the matching hole 135 and the positioning hole 134 corresponding thereto, thereby positioning the lower end of the rear support stem 30. It is also possible that the adjusting tube 132 and the locking button 133 release from the adaptive slot along with the rear support stem 30. Thus, the rear support stem can be detached from the rear frame.

Referring to FIG. 11, a height adjustment structure at the front end of the walker chair is disclosed. A height adjustment seat 41 is connected to the front end of the walker chair 40. The height adjustment seat 41 at least includes a pivot part 411 and a positioning part 412 which are in up and down positions. The height adjustment seat 41 is relatively rotatably connected to the front end of the walker chair 40 by the pivot part 411. The positioning part 412 is capable of being located above or below the pivot part 411 according to a rotation of the height adjustment seat 41. A positioning adaptive part 21 is disposed on the front support 20. The positioning part 412 of the height adjustment seat 41 and the positioning adaptive part 21 interlock in position. The front end of the walker chair can turn around the height adjustment seat 41, equivalent to turning around the front support 20, in order to execute the folding and unfolding operations.

Referring to FIG. 1 and FIG. 7 through FIG. 9, the infant walker of this invention is a foldable structure, the folding processes of which are shown in the aforesaid four figures. The folded structure is described as follows:

(1) The front support 20 forms a chamber 22 for accommodating the scooter chair assembly 50, and the chamber 22 has a rear opening. As shown in FIG. 1, the folding action is executed by separating the scooter chair 51 from the rear end of the connecting support stem 52, then folding the connecting support stem 52 by turning and putting it inside the chamber 22, and thence locking the rear end of the scooter chair 51 with the front end of the connecting support stem 52. Thus, the entire scooter chair assembly 50 can be stored in the chamber 22. It is noted that the upper end of the rear support stem 30 and the front end of the connecting support stem 52 have the same connecting point 60, and the rear end of the scooter chair 51 is detachably adapted to these two connecting points 60.

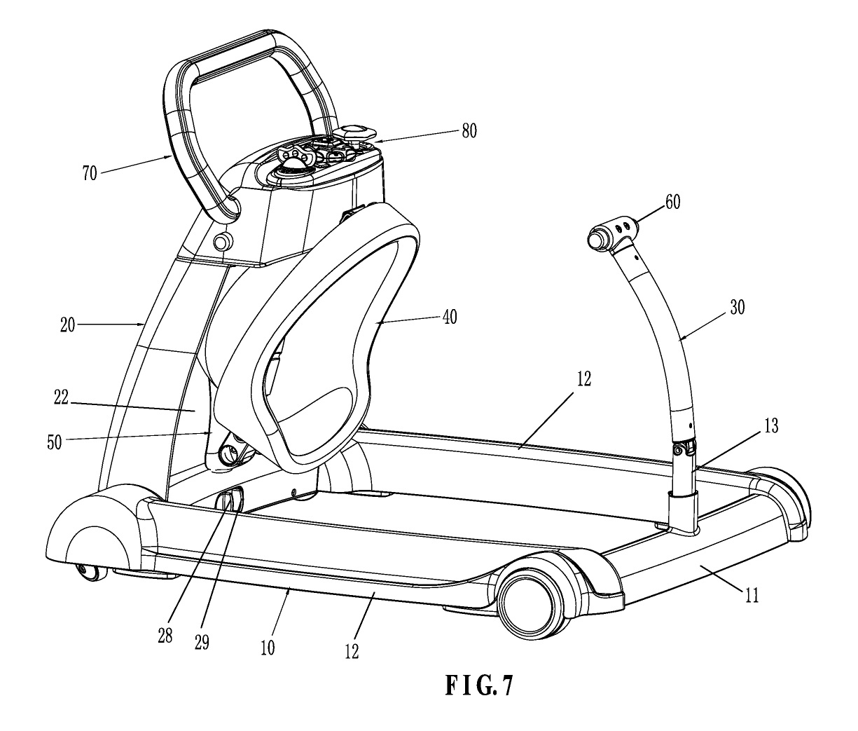

(2) The walker chair 40 can turn around the pivot part 411 so that the walker chair 40 can move forward and then downward to become folded as shown in FIG. 7.

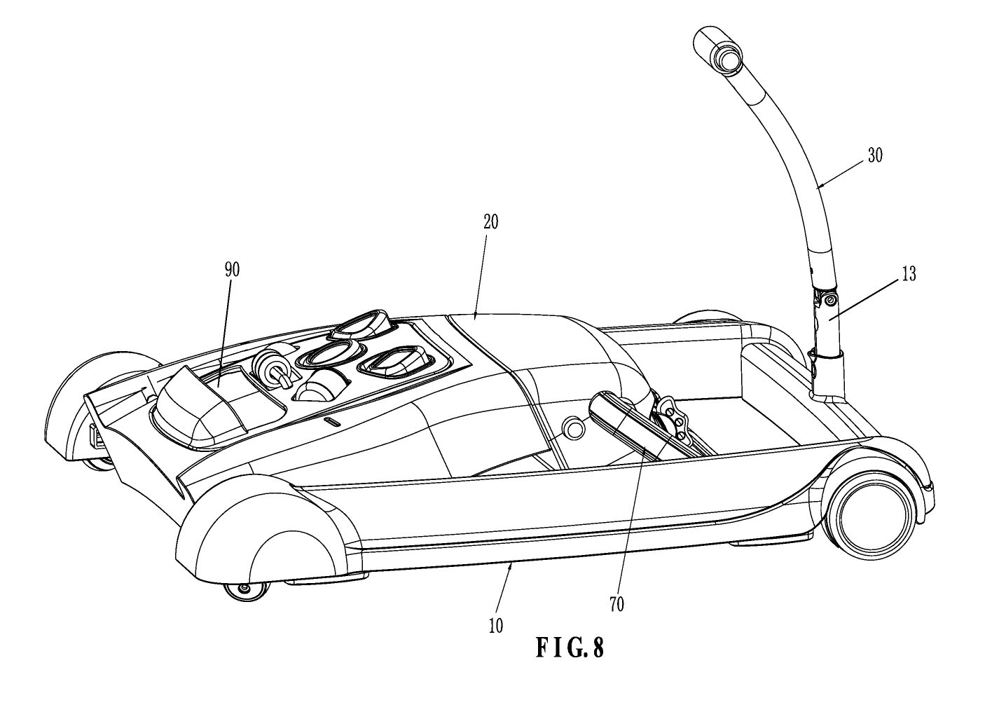

(3) The front support 20 relative to the base 10 is rotatable. The left and the right of the lower end of the front support 20 are respectively pivotally connected to the left and the right side frame 12. The lower end of the front support 20 is deemed as a front frame of the base of the conventional structure. Before the front support 20 is folded, the locking relations between the front support 20 and the base 10 must be liberated. Specifically, the liberating operation is executed by pulling the left pull button 28 and the right pull button 29 toward the middle, then using the left cable 26 and the right cable 27 to release the left locking part 24 and the right locking part 25 from the locking bores 122, and thence turning the front support 20 rearward and downward to become folded as shown in FIG. 8. Preferably, a ring-shaped handlebar 70 is disposed at the upper end of the front support 20 and is capable of being relatively turned around the front support 20. During the folding operation, the ring-shaped handlebar 70 can be folded by turning if required.

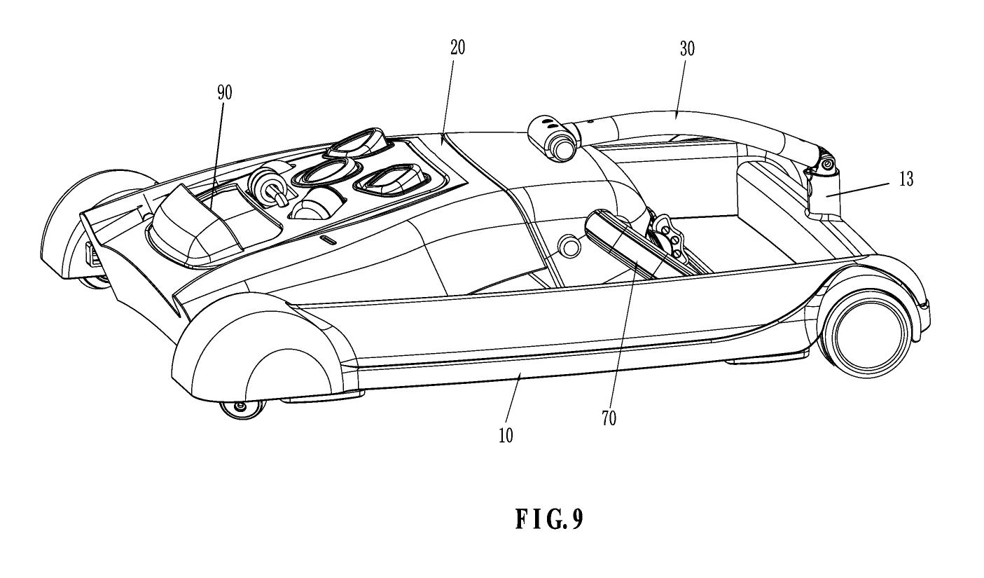

(4) The lower end of the rear support stem 30 can be relatively rotatably connected to the upper end of the adjusting tube 132 so that the rear support stem 30 can be turned forward and downward to become folded as shown in FIG. 9.

When comparing FIG. 1 with FIG. 9, this invention clearly has a reduced folded volume because of a large reduction in the height of the infant walker. The folding operation is easy, and the folded structure has a dense arrangement. The unfolding operation is also convenient.

Further, an amusement table 80, on which toys, sounding devices or all of them can be installed, may be disposed at the upper end of the front support 20. A front side of the front support 20 can have decorations, toys or all of them mounted thereon. The front side of the front support 20 can also form a storage room 90 for storing goods.

The feature of this invention is that the front support and the rear support which performs a folding motion by turning relative to the base to allow the folded infant walker to have a large reduction in the whole volume. Thus, this invention is easy to carry, store and manage and is also provided with a simple and convenient folding operation. Further, by the connection between the walker chair, the scooter chair assembly and the rear support stem, the connecting support stem can be folded by turning and stored in the chamber, the rear end of the scooter chair can be adapted to the front end of the connecting support stem and positioned within the chamber, and the walker chair can be turned and then folded to abut against the scooter chair. Thus, the walker chair and the scooter chair assembly are concurrently turned rearward along with the front support and then folded to enter the base. This discloses a complete folded structure with detailed components held in position. Therefore, there are no separate accessories, and the occurrence of losing the accessories is prevented.

While the embodiments of this invention are disclosed and shown, it is understood that further variations and modifications may be made without departing from the scope of this invention.

What is claimed is:

1. A foldable infant walker comprising a base, a front support, a rear support and a walker chair, respective bottom ends of said front support and said rear support being disposed relative to said base and rotatably connected to said base, a front end of said walker chair being detachably connected to an upper end of said front support, a rear end of said walker chair being detachably connected to an upper end of said rear support.

2. The foldable infant walker as claimed in claim 1, wherein said base includes a rear frame, a left side frame connected to a left end of said rear frame and a right side frame connected to a right end of said rear frame, a lower left end of said front support being pivotally connected to said left side frame, a lower right end of said front support being pivotally connected to said right side frame.

3. The foldable infant walker as claimed in claim 2, wherein said two ends of said rear frame are detachably connected to respective rear ends of said left side frame and said right side frame.

4. The foldable infant walker as claimed in claim 2, wherein said rear support includes a rear support stem, said rear end of said walker chair being detachably connected to an upper end of said rear support stem, a lower end of said rear support stem being disposed relative to said rear frame and rotatably connected to said rear frame.

5. The foldable infant walker as claimed in claim 4, wherein a connecting part extends upward from a middle portion of said rear frame and includes a tube seat, an adjusting tube and a locking button, said lower end of said rear support stem being relatively rotatably connected to an upper end of said adjusting tube, a lower end of said tube seat being connected to said middle portion of said rear frame, an adaptive slot being longitudinally extended in said tube seat, a positioning hole which is exposed to an outside being formed on a slot wall of said adaptive slot, said adjusting tube having a hollow inside, said adjusting tube being capable of sliding into said adaptive slot of said tube seat, at least two spaced-apart matching holes being formed on a tube wall of said adjusting tube, an up-down sliding motion of said adjusting tube penetrating said locking button through said matching hole and said positioning hole corresponding thereto to position said lower end of said rear support stem.

6. The foldable infant walker as claimed in claim 1, wherein said front end of said walker chair being relatively rotatably connected to said front support, a height adjustment seat being connected to said front end of said walker chair, said height adjustment seat at least including a pivot part and a positioning part which are in up and down positions, said height adjustment seat being relatively rotatably connected to said front end of said walker chair by said pivot part, said positioning part being capable of being located above or below said pivot part according to a rotation of said height adjustment seat, a positioning adaptive part being disposed on said front support, said positioning part of said height adjustment seat and said positioning adaptive part interlocking in position.

7. The foldable infant walker as claimed in claim 2, wherein a rotating locking assembly is disposed between said front support and said base, said rotating locking assembly including a connecting axle, a left locking part, a right locking part, a left cable, a right cable, a left pull button and a right pull button, said connecting axle being connected between respective front ends of said left side frame and said right side frame, said left locking part and said right locking part being wound round said connecting axle, said left cable being connected between said left pull button and said left locking part, said right cable being connected between said right pull button and said right locking part, a bottom portion of said front support being rotatably wound round said connecting axle, a left and a right of said bottom portion of said front support forming respective adapter openings, respective adapter posts projecting from said left side frame and said right side frame, a locking bore being formed on each of said adapter posts, said adapter posts penetrating said adapter openings, said left locking part and said right locking being lodged in or withdrawn from said locking bores corresponding thereto with an operation of said left pull button and said right pull button.

8. The foldable infant walker as claimed in claim 1, further comprising a scooter chair assembly, wherein said scooter chair assembly includes a scooter chair and a connecting support stem connected to a front end of said scooter chair, a front end of said connecting support stem being detachably connected to said front support or relatively rotatably connected thereto by turning around said front support, a rear end of said scooter chair being detachably connected to an upper end of said rear support stem.

9. The foldable infant walker as claimed in claim 8, wherein said front support forms a chamber for accommodating said scooter chair assembly, said chamber having a rear opening, said upper end of said rear support stem having a first connecting point which is the same as a second connecting point at said front end of said connecting support stem, said rear end of said scooter chair being detachably adapted to said first connecting point and said second connecting point.

10. The foldable infant walker as claimed in claim 1, wherein a ring-shaped handlebar is disposed at said upper end of said front support and is capable of being relatively turned around said front support.
